(19) United States
(12) Patent Application Publication
(10) Pub. No.: US 2026/0010521 A1
(43) Pub. Date: Jan. 8, 2026

(54) ABNORMAL DATA CLEANING METHOD AND SYSTEM FOR WIND SPEED-POWER CURVES

(71) Applicants: CHINA DATANG CORPORATION SCIENCE AND TECHNOLOGY GENERAL RESEARCH INSTITUTE CO.LTD EAST CHINA ELECTRI, Hefei (CN); DATANG BOILER PRESSURE VESSEL INSPECTION CENTER CO., LTD., Hefei (CN); DATANG SANYA FUTURE ENERGY RESEARCH INSTITUTE CO., LTD., Sanya (CN)

(72) Inventors: Yun Chen, Hefei (CN); Shenhua DAI, Hefei (CN); Shengqiang JI, Hefei (CN); Yuepeng HU, Hefei (CN); Zhigang RUI, Hefei (CN); Shengwen WANG, Hefei (CN)

(21) Appl. No.: 19/275,947

(22) Filed: Jul. 21, 2025

Related U.S. Application Data
(63) Continuation of application No. PCT/CN2024/125536, filed on Oct. 17, 2024.

(30) Foreign Application Priority Data
Jul. 4, 2024 (CN) 202410893999.0

(51) Int. Cl. G06F 16/215; G06F 16/28

(52) U.S. Cl. CPC G06F 16/215; G06F 16/287

(57) ABSTRACT

The present application provides an abnormal data cleaning method for wind speed-power curves and a corresponding system. The method comprises: importing standard wind speed-power data and plotting a standard wind speed-power curve; importing actual wind turbine data, including wind speed and power, and plotting the actual wind speed-power scatter plot; partitioning the data interval-wise based on wind speed and performing DBSCAN clustering on the data within each interval; determining a segmented dynamic threshold line and conducting secondary cleaning on the data after DBSCAN clustering; partitioning the cleaned data according to the wind speed intervals defined in step three, calculating the average power within each interval to obtain the wind speed-power data predicted from the actual data, thereby plotting the actual wind speed-power curve.

### TECHNICAL FIELD

The present application relates to the technical field of actual wind power curve prediction and specifically relates to an abnormal data cleaning method and system for wind speed-power curves.

### BACKGROUND

The wind speed-power curve of a wind turbine reflects the power output at different wind speeds. This information plays a crucial role in evaluating the actual operational capability and power generation capacity of the unit and serves as an important reference for optimizing wind turbine control strategies. In the post-warranty acceptance process of wind turbines, the consistency of the wind power curve is a key parameter for evaluating the operational performance indicators of the wind turbine. This requires the collection of a large volume of wind speed and power data. However, due to the complex environment in which the wind turbine operates, as well as factors intrinsic to the turbine itself, the actual data obtained often contains a significant amount of abnormal and unreliable data points, resulting in an unreliable wind speed-power curve. Therefore, to ensure the accuracy of the final wind speed-power curve and the power consistency coefficient, it is particularly important to perform data cleaning and selection on the collected data.

Currently, there are numerous data cleaning methods, with common approaches including k-means clustering, DBSCAN clustering, and the Thomps tau method. The k-means clustering algorithm is an unsupervised learning algorithm that partitions data points into clusters based on Euclidean distance and is characterized by its simple implementation and high computational efficiency. However, determining the optimal value of k is a relatively complex task that requires multiple experimental comparisons. Furthermore, the K-means algorithm performs poorly on data with non-spherical clusters. The DBSCAN clustering algorithm is a density-based clustering method that partitions data points by defining a neighborhood radius (Eps) and the minimum number of samples within the neighborhood (Minpts). As the installed capacity of wind power increases annually, the volatility and stochastic nature of wind power have a significant impact on grid integration. Due to the uncertainty of wind speed and wind energy, it is necessary to obtain a reliable actual wind speed-power curve to address this issue, which is crucial for ensuring the stable operation of wind power systems and maximizing power generation efficiency. However, existing wind speed-power curve generation methods exhibit certain limitations in processing abnormal data points. Therefore, a new method is required to eliminate these abnormal data points, thereby better accommodating data from various wind turbine models.

The present application addresses the technical issues in the prior art of wind power forecasting, specifically the inadequate accuracy and comprehensiveness of data cleaning operations, as well as the limited applicability of data cleaning to different types of data.

### SUMMARY

The technical problem to be solved by the present application is the inadequate accuracy and comprehensiveness of data cleaning operations in the prior art of wind power forecasting, as well as the limited applicability of data cleaning to different types of data.

The present application addresses the aforementioned technical problems by employing the following technical solution: an abnormal data cleaning method for wind speed-power curves comprising:
S1. importing standard wind speed-power data to obtain a standard wind speed-power curve;
S2. collecting and importing actual wind turbine data, wherein the actual wind turbine data comprises wind speed and power;
S3. performing coarse-grained data cleaning, wherein partitioning the actual wind turbine data interval-wise based on the wind speed in the actual wind turbine data, so as to obtain no fewer than two wind speed intervals; performing DBSCAN clustering on the actual wind turbine data within each wind speed interval to obtain DBSCAN clustered data;
S4. performing fine-grained data cleaning, wherein determining boundary points of segments and applying different fine-grained cleaning strategies to different interval segments, wherein the fine-grained cleaning strategies comprise dynamic threshold cleaning and static threshold cleaning, performing cleaning operations on the DBSCAN clustered data to obtain noise-filtered data;
S5. partitioning the noise-filtered data according to the wind speed intervals partitioned in Step S3, calculating average power within each wind speed interval to obtain a predicted wind speed-power data, and thereby plotting an actual wind speed-power curve.

The present application employs a method that combines DBSCAN clustering with dynamic thresholding, enabling the cleaning of abnormal data based on the intrinsic characteristics of the data. Furthermore, the dynamic threshold can better fit the trend of the original data, resulting in more accurate identification of abnormal data and more comprehensive cleaning.

In a more specific technical solution, the step S3 utilizes the following logic to perform interval partitioning on the actual wind turbine data:

$$\{ ( v 1 - \frac{v 2 - v 1}{2} , v 1 + \frac{v 2 - v 1}{2} ) , ( v 2 - \frac{v 2 - v 1}{2} , v 2 + \frac{v 2 - v 1}{2} ) , ( v 3 - \frac{v 2 - v 1}{2} , v 3 + \frac{v 2 - v 1}{2} ) … \} ∘$$

wherein v1, v2, v3 are wind speeds in the standard wind speed-power data.

In a more specific technical solution, the DBSCAN clustering operation in the step S3 comprises:
S31. randomly selecting an unvisited data point p;
S32. inspecting, with the unvisited data point p as the center, within a predefined radius to identify core points and create a new cluster;
S33. recursively inspecting, for each of the core points, a secondary neighbor point of a neighbor point of the core points, and adding these secondary neighbor points to the current cluster;
S34. iteratively performing the steps S32 to S33 until all core points within a range determined by the predefined radius have been visited;
S35. if a non-core point within the range determined by the predefined radius is unvisited, marking the non-core point as noise.

In a more specific technical solution, the step S32 includes:
S321. traversing, for the neighbor points within the predefined radius Eps, and determining whether the number of neighbors of each neighbor point is greater than or equal to a predefined minimum number of neighbors MinPts;
S322. if so, marking the current neighbor point as a core point and accordingly creating the current cluster.

In a more specific technical solution, in the step S35, the noise comprises noise points and boundary points.

In a more specific technical solution, the step S4 comprises:
S41. determining an abnormal data cleaning threshold based on characteristics of data when the wind speed is greater than or equal to a preset minimum full-power wind speed, so as to serve as the boundary point between a first interval segment and a second interval cleaning segment;
S42. calculating a noise filtering dynamic threshold line in a first interval phase, based on a ratio of actual power to predicted power for all data within the interval;
S43. in a second interval phase, removing noise in the second interval by comparing the actual power of the wind turbine with the power ratio threshold, when the wind speed is greater than the minimum full-power wind speed.

The present application is based on the intrinsic characteristics of the data, automatically formulating distinct dynamic threshold lines for different datasets. Furthermore, for various turbine models, different standard wind speed-power data can be imported to better accommodate diverse data from different models, thereby enhancing the applicability of the data cleaning scheme.

In a more specific technical solution, in the step S41, statistically determining a corresponding preset minimum full-power wind speed when the power in the wind speed-power data is constant, so as to serve as the boundary point between the first interval phase and the second interval phase.

In a more specific technical solution, in the step S42, determining the ratio of the actual power to the predicted power at different power levels using a statistical method, and fitting a linear function based on the wind speed and the ratio of the actual power to the predicted power, so as to serve as a segmented dynamic threshold line for the first interval.

In a more specific technical solution, an abnormal data cleaning system for wind speed-power curve comprises:
a standard curve plotting module, configured to import standard wind speed-power data to obtain a standard wind speed-power curve;
an actual curve plotting module, configured to collect and import actual wind turbine data, wherein the actual wind turbine data comprises wind speed and power, to plot an actual wind speed-power scatter plot;
an interval clustering module, configured to perform coarse-grained data cleaning, to partition the actual wind turbine data interval-wise based on the wind speed in the actual wind turbine data, so as to obtain no fewer than two wind speed intervals; to perform DBSCAN clustering on the actual wind turbine data within each wind speed interval to obtain DBSCAN clustered data, wherein the interval clustering module is connected to the actual curve plotting module;
a data cleaning module, configured to perform fine-grained data cleaning, to determine boundary points of segments and applying different fine-grained cleaning strategies to different interval segments, wherein the fine-grained cleaning strategies comprise dynamic threshold cleaning and static threshold cleaning, performing cleaning operations on the DBSCAN clustered data to obtain noise-filtered data, wherein the data cleaning module is connected to the interval clustering module;
an actual wind speed-power curve plotting module, configured to partition the noise-filtered data according to the wind speed intervals partitioned in the step S3, calculate average power within each wind speed interval to obtain a predicted wind speed-power data, and thereby plot an actual wind speed-power curve, wherein the actual wind speed-power curve plotting module is connected to the data cleaning module and the interval clustering module.

The present application offers the following advantages over the prior art:

The present application employs a method that combines DBSCAN clustering with dynamic thresholding, enabling the cleaning of abnormal data based on the intrinsic characteristics of the data. Furthermore, the dynamic threshold can better fit the trend of the original data, resulting in more accurate identification of abnormal data and more comprehensive cleaning.

The present application is based on the intrinsic characteristics of the data, automatically formulating distinct dynamic threshold lines for different datasets. Furthermore, for various turbine models, different standard wind speed-power data can be imported to better accommodate diverse data from different models, thereby enhancing the applicability of the data cleaning scheme.

The present application addresses the technical issues of inadequate accuracy and comprehensiveness in data cleaning operations, as well as the low applicability of data cleaning to different types of data, which exist in current wind power forecasting technologies.

### BRIEF DESCRIPTION OF THE DRAWINGS

FIG. 1 is a schematic diagram illustrating the basic steps of the abnormal data cleaning method for wind speed-power curves according to Embodiment 1 of the present application;

FIG. 2 is a schematic diagram illustrating the specific implementation steps of the DBSCAN clustering algorithm according to Embodiment 1 of the present application;

FIG. 3 is a schematic diagram illustrating the specific implementation steps of the abnormal data cleaning method for wind speed-power curves according to Embodiment 1 of the present application;

FIG. 4 is a standard wind speed-power curve according to Embodiment 1 of the present application.

FIG. 5 is a wind speed-power scatter plot according to Embodiment 1 of the present application.

FIG. 6a is a schematic diagram of the wind speed-power curve in a first phase according to Embodiment 1 of the present application.

FIG. 6b is a schematic diagram of the wind speed-power curve in a second phase according to Embodiment 1 of the present application.

FIG. 7 is an actual wind speed-power curve according to Embodiment 1 of the present application.

### DETAILED DESCRIPTION

To further clarify the objectives, technical solution, and advantages of the embodiments of the present application, the technical solution of the embodiments will be described clearly and comprehensively below in conjunction with the embodiments. It is evident that the described embodiments constitute part, but not all, of the embodiments of the present application. Based on the embodiments of the present application, all other embodiments obtained by those of ordinary skill in the art without inventive effort fall within the scope of protection of the present application.

### Embodiment 1

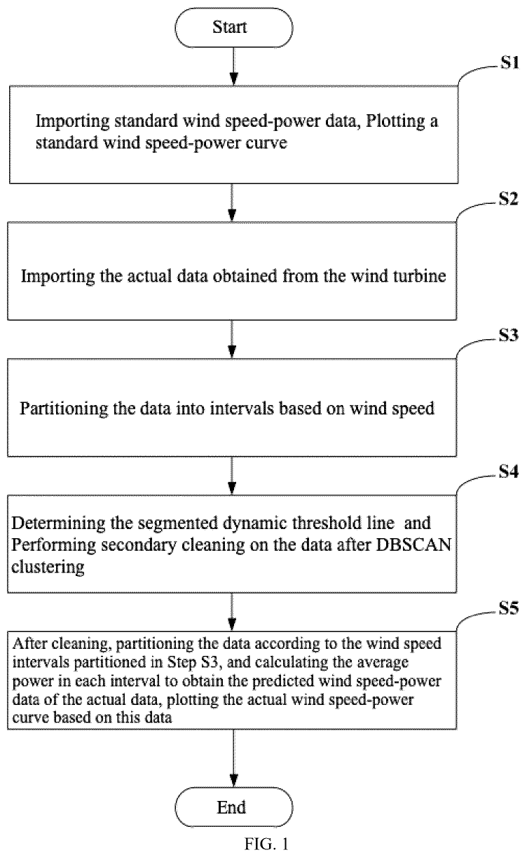

As shown in FIG. 1, the abnormal data cleaning method for wind speed-power curves provided by the present application comprises the following basic steps:
Step S1: importing standard wind speed-power data to obtain a standard wind speed-power curve;
In this embodiment, the standard wind speed-power data is imported, v={v1, v2, v3 . . . }, s={s1, s2, s3 . . . }, and a standard wind speed-power curve chart is plotted;
Step S2: importing the actual data obtained from the wind turbine;
In this embodiment, the actual data obtained from the wind turbine includes, but is not limited to, wind speed and power, and the actual wind speed-power scatter plot is constructed.
Step S3: partitioning the data into intervals based on wind speed.

$$\{ ( v 1 - \frac{v 2 - v 1}{2} , v 1 + \frac{v 2 - v 1}{2} ) , ( v 2 - \frac{v 2 - v 1}{2} , v 2 + \frac{v 2 - v 1}{2} ) , ( v 3 - \frac{v 2 - v 1}{2} , v 3 + \frac{v 2 - v 1}{2} ) … \} ,$$

performing DBSCAN clustering on the data within each interval.

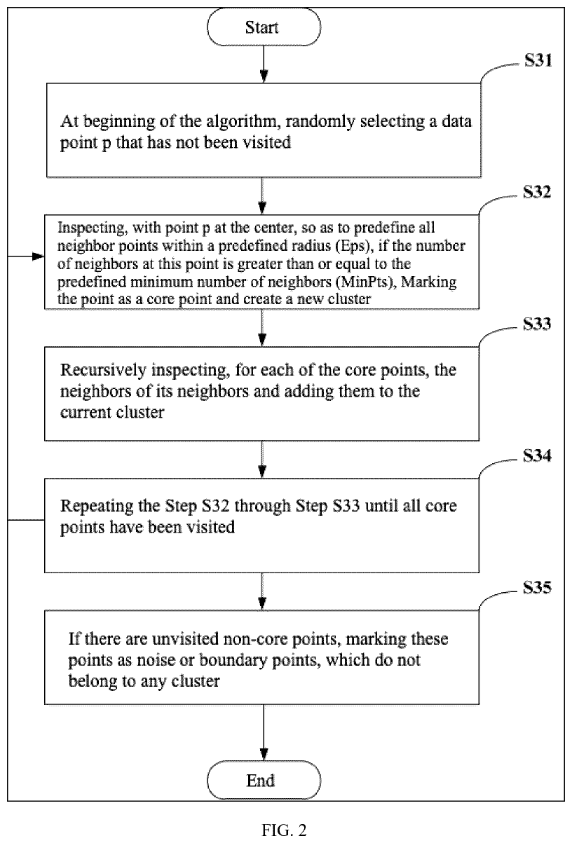

As shown in FIG. 2, in this embodiment, the DBSCAN clustering algorithm further comprises the following specific implementation steps:
S31: at the start of the algorithm, randomly selecting an unvisited data point p.
S32: inspecting, with point p at the center, so as to predefine all neighbor points within a predefined radius (Eps), if the number of neighbors at this point is greater than or equal to the predefined minimum number of neighbors (MinPts), marking the point as a core point and create a new cluster.
S33. recursively inspecting, for each of the core points, the neighbors of its neighbors and adding them to the current cluster.
S34. repeating the Step S32 through Step S33 until all core points have been visited.
S35. if there are unvisited non-core points, marking these points as noise or boundary points, which do not belong to any cluster.

Step S4. determining the segmented cleaning boundary point and performing secondary cleaning on the data after DBSCAN clustering.

In this embodiment, during the first interval phase, when the wind speed is less than the minimum full-power wind speed, a statistical method is employed to determine the actual and predicted power ratios at different power levels. Based on the wind speed and the actual and predicted power ratios, a linear function is fitted to serve as the segmented dynamic threshold line for the first interval. Simultaneously, based on the results of DBSCAN clustering, a wind speed-power curve is fitted. When the actual wind speed is less than the minimum full-power wind speed, the corresponding predicted power is calculated. The ratio of actual power to predicted power (the smaller divided by the larger) is then computed and compared with the threshold. If the ratio is less than the threshold, it is marked as noise. During the second interval phase, when the wind speed exceeds the minimum full-power wind speed, the threshold is set to 0.96 times the rated power. If the actual power is less than this threshold, it is labeled as noise.

In this embodiment, during the determination of the segmented threshold, in the standard wind speed-power curve, when the current wind speed exceeds the preset minimum full-power wind speed, the power curve remains horizontal, and the power value is constant. Therefore, the minimum full-power wind speed can be identified from the standard wind speed-power data using statistical methods.

In this embodiment, during the determination of the data cleaning threshold, the data is partitioned into two intervals based on the determined segmented threshold: less than the preset minimum full-power wind speed and greater than the preset minimum full-power wind speed, hereinafter referred to as the first interval and the second interval. Due to the significant differences in data distribution between the two intervals, two different abnormal value removal methods are employed for these intervals in this paper.

In this embodiment, prior to implementing the two abnormal value cleaning methods, polynomial features are first generated for both the complete actual wind speed data and the wind speed data cleaned by DBSCAN, resulting in two types of polynomial features, referred to as the first feature and the second feature. Subsequently, a polynomial regression model in machine learning is used to fit the second feature and the corresponding power data, thereby obtaining a polynomial regression model. Finally, a regression model is employed to predict the corresponding power data of the first feature as the predicted power; two abnormal value cleaning methods are then applied. The commonalities between the two methods include:

Abnormal data are removed by determining whether the ratio of predicted power to actual power is less than a specified value. In the first abnormal value cleaning method, this value is dynamically set according to wind speed, whereas in the second method, the value is fixed.

In the threshold determination method for the first interval in this embodiment, a statistical method is utilized to determine the ratio between different predicted and actual power values, with the larger value serving as the denominator. A linear function is fitted based on wind speed and this ratio to serve as the dynamic threshold line for interval 1.

In the method for determining the threshold of the second interval in this embodiment, since the standard power is a constant value when the wind speed exceeds the segmented threshold, and considering the actual data, the actual power also tends to approach a constant value when the wind speed exceeds the segmented threshold. Therefore, a static threshold is set for the interval 2.

Step S5: After cleaning, partitioning the data according to the wind speed intervals partitioned in Step S3, and calculating the average power in each interval to obtain the predicted wind speed-power data of the actual data {(v1, s1′), (v2, s2′), (v3, s3′) . . . }, and plotting the actual wind speed-power curve based on this data.

### Embodiment 2

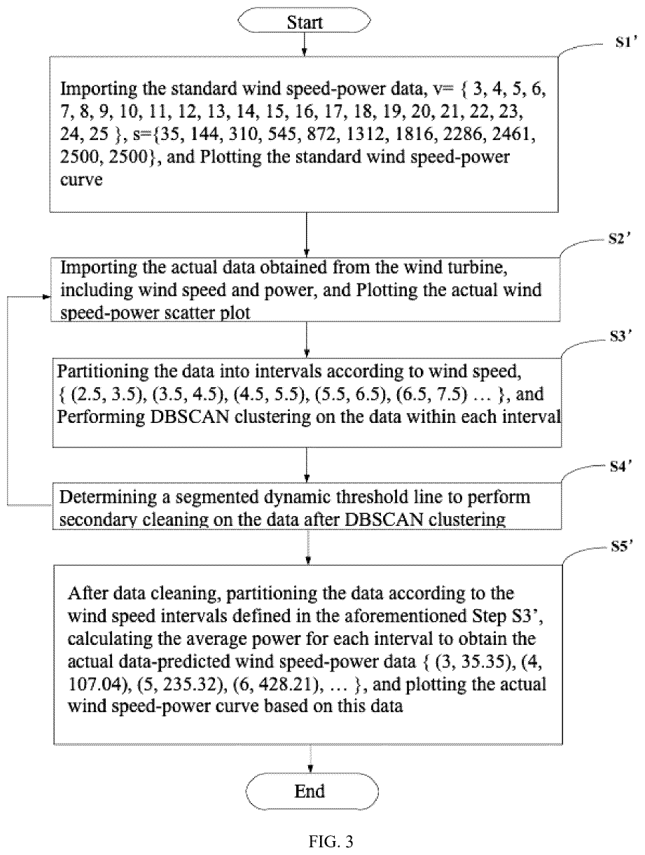

As shown in FIG. 3, in this embodiment, the abnormal data cleaning method for wind speed-power curves further comprises the following specific implementation steps:

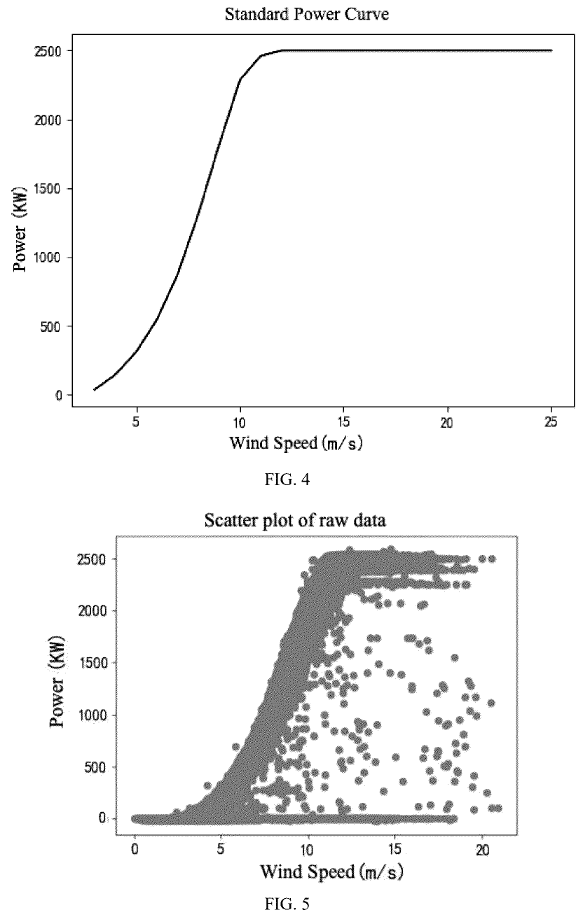

Step S1′: As shown in FIG. 4, importing the standard wind speed-power data, v={3, 4, 5, 6, 7, 8, 9, 10, 11, 12, 13, 14, 15, 16, 17, 18, 19, 20, 21, 22, 23, 24, 25}, s={35, 144, 310, 545, 872, 1312, 1816, 2286, 2461, 2500, 2500}, and plotting the standard wind speed-power curve;

Step S2′: As shown in FIG. 5, importing the actual data obtained from the wind turbine, including wind speed and power, and plotting the actual wind speed-power scatter plot.

Step S3′: partitioning the data into intervals according to wind speed, {(2.5, 3.5), (3.5, 4.5), (4.5, 5.5), (5.5, 6.5), (6.5, 7.5) . . . }, and performing DBSCAN clustering on the data within each interval.

In the DBSCAN clustering algorithm employed in this embodiment, the algorithm begins by randomly selecting an unvisited data point p. Inspect all neighbor points within a predefined radius (Eps=0.5) centered at point p. If the number of neighbors is greater than or equal to the predefined minimum number of neighbors (MinPts=2), mark the point as a core point and create a new cluster. For each core point, recursively inspect the neighbors of its neighbors and add them to the current cluster; repeat this process until all core points have been visited. If there are unvisited non-core points, these points are marked as noise or boundary points and do not belong to any cluster.

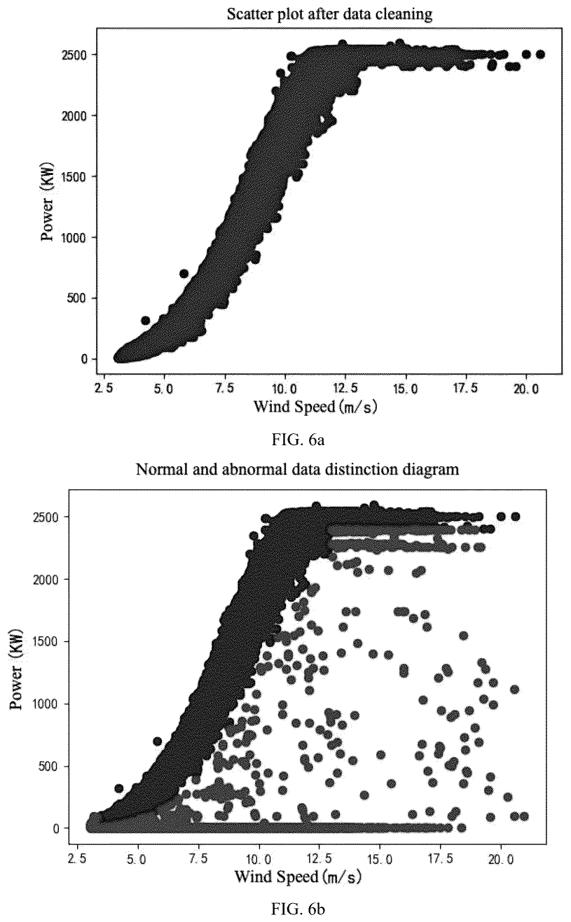

Step S4′: As shown in FIGS. 6a and 6b, determining a segmented dynamic threshold line to perform secondary cleaning on the data after DBSCAN clustering. In this embodiment, during the first interval phase, when the wind speed is less than 12 m/s, it is experimentally determined that a threshold of 0.7 yields better removal for wind speeds greater than 12 m/s, and a threshold of 0.05 is more effective for wind speeds less than 2.5 m/s. A straight line is established as the dynamic threshold line based on these two points. Meanwhile, based on the results after DBSCAN clustering, a wind speed-power curve is fitted, and the predicted power corresponding to actual wind speeds below the minimum full-power wind speed is calculated. The actual power and the predicted power are compared (the smaller divided by the larger) to obtain their ratio, which is then compared with the threshold. If the ratio is less than the threshold, it is marked as noise. In the second interval phase of this embodiment, when the wind speed exceeds the minimum full-power wind speed, the threshold is set to (0.96*2500), and any actual power below this threshold is identified as noise.

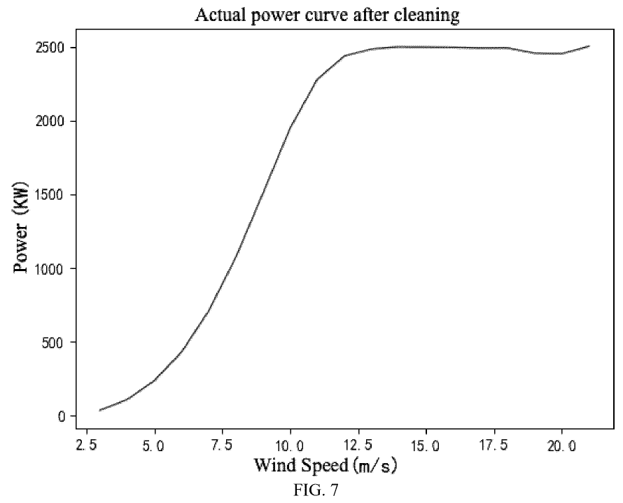

Step S5′: As shown in FIG. 7, after data cleaning, partitioning the data according to the wind speed intervals defined in the aforementioned Step S3′, calculating the average power for each interval to obtain the actual data-predicted wind speed-power data {(3, 35.35), (4, 107.04), (5, 235.32), (6, 428.21), . . . }, and plotting the actual wind speed-power curve based on this data.

The present application employs a method that combines DBSCAN clustering with dynamic thresholding, enabling the cleaning of abnormal data based on the intrinsic characteristics of the data. Furthermore, the dynamic threshold can better fit the trend of the original data, resulting in more accurate identification of abnormal data and more comprehensive cleaning.

The present application is based on the intrinsic characteristics of the data, automatically formulating distinct dynamic threshold lines for different datasets. Furthermore, for various turbine models, different standard wind speed-power data can be imported to better accommodate diverse data from different models, thereby enhancing the applicability of the data cleaning scheme.

The present application addresses the technical issues of inadequate accuracy and comprehensiveness in data cleaning operations, as well as the low applicability of data cleaning to different types of data, which exist in current wind power forecasting technologies.

The above embodiments are provided solely to illustrate the technical solution of the present application and are not intended to limit it. Although the present application has been described in detail with reference to the foregoing embodiments, those of ordinary skill in the art should understand that modifications may still be made to the technical solutions described in the above embodiments, or that some technical features may be equivalently substituted. Such modifications or substitutions do not cause the essence of the corresponding technical solutions to depart from the spirit and scope of the technical solutions of the embodiments of the present application.

What is claimed is:

1. An Abnormal data cleaning method for wind speed-power curves, the method comprising:
S1. importing standard wind speed-power data to obtain a standard wind speed-power curve;
S2. collecting and importing actual wind turbine data, wherein the actual wind turbine data comprises wind speed and power, to plot an actual wind speed-power scatter plot;
S3. performing coarse-grained data cleaning, wherein partitioning the actual wind turbine data interval-wise based on the wind speed in the actual wind turbine data, so as to obtain no fewer than two wind speed intervals; performing DBSCAN clustering on the actual wind turbine data within each wind speed interval to obtain DBSCAN clustered data;
S4. performing fine-grained data cleaning, wherein determining boundary points of segments and applying different fine-grained cleaning strategies to different interval segments, wherein the fine-grained cleaning strategies comprise dynamic threshold cleaning and static threshold cleaning, performing cleaning operations on the DBSCAN clustered data to obtain noise-filtered data;
S5. partitioning the noise-filtered data according to the wind speed intervals partitioned in Step S3, calculating average power within each wind speed interval to obtain a predicted wind speed-power data, and thereby plotting an actual wind speed-power curve.

2. The abnormal data cleaning method for wind speed-power curves according to claim 1, wherein in the step S3, the following logic is used to perform interval partitioning on the actual wind turbine data:
$$\{ ( v 1 - \frac{v 2 - v 1}{2} , v 1 + \frac{v 2 - v 1}{2} ) , ( v 2 - \frac{v 2 - v 1}{2} , v 2 + \frac{v 2 - v 1}{2} ) , ( v 3 - \frac{v 2 - v 1}{2} , v 3 + \frac{v 2 - v 1}{2} ) … \}$$
wherein v1, v2, v3 are wind speeds in the standard wind speed-power data.

3. The abnormal data cleaning method for wind speed-power curves according to claim 1, wherein the DBSCAN clustering in the step S3 comprises:
S31. randomly selecting an unvisited data point p;
S32. inspecting, with the unvisited data point p as the center, within a predefined radius to identify core points and create a new cluster;
S33. recursively inspecting, for each of the core points, a secondary neighbor point of a neighbor point of the core points, and adding these secondary neighbor points to the current cluster;
S34. iteratively performing the steps S32 to S33 until all core points within a range determined by the predefined radius have been visited;
S35. if a non-core point within the range determined by the predefined radius is unvisited, marking the non-core point as noise.

4. The abnormal data cleaning method for wind speed-power curves according to claim 3, wherein the step S32 comprises:
S321. traversing, for the neighbor points within the predefined radius Eps, and determining whether the number of neighbors of each neighbor point is greater than or equal to a predefined minimum number of neighbors MinPts;
S322. if so, marking the current neighbor point as a core point and accordingly creating the current cluster.

5. The abnormal data cleaning method for wind speed-power curves according to claim 3, wherein in the step S35, the noise comprises noise points and boundary points.

6. The abnormal data cleaning method for wind speed-power curves according to claim 1, wherein the step S4 comprises:
S41. determining an abnormal data cleaning threshold based on characteristics of data when the wind speed is greater than or equal to a preset minimum full-power wind speed, so as to serve as the boundary point between a first interval segment and a second interval cleaning segment;
S42. calculating a noise filtering dynamic threshold line in a first interval phase, based on a ratio of actual power to predicted power for all data within the interval;
S43. in a second interval phase, removing noise in the second interval by comparing the actual power of the wind turbine with the power ratio threshold, when the wind speed is greater than the minimum full-power wind speed.

7. The abnormal data cleaning method for wind speed-power curves according to claim 6, wherein, in the step S41, statistically determining a corresponding preset minimum full-power wind speed when the power in the wind speed-power data is constant, so as to serve as the boundary point between the first interval phase and the second interval phase.

8. The abnormal data cleaning method for wind speed-power curves according to claim 6, wherein, in the step S42, determining the ratio of the actual power to the predicted power at different power levels using a statistical method, and fitting a linear function based on the wind speed and the ratio of the actual power to the predicted power, so as to serve as a segmented dynamic threshold line for the first interval.

9. An abnormal data cleaning system for wind speed-power curve, comprising:
a standard curve plotting module, configured to import standard wind speed-power data to obtain a standard wind speed-power curve;
an actual curve plotting module, configured to collect and import actual wind turbine data, wherein the actual wind turbine data comprises wind speed and power, to plot an actual wind speed-power scatter plot;
an interval clustering module, configured to perform coarse-grained data cleaning, to partition the actual wind turbine data interval-wise based on the wind speed in the actual wind turbine data, so as to obtain no fewer than two wind speed intervals; to perform DBSCAN clustering on the actual wind turbine data within each wind speed interval to obtain DBSCAN clustered data, wherein the interval clustering module is connected to the actual curve plotting module;
a data cleaning module, configured to perform fine-grained data cleaning, to determine boundary points of segments and applying different fine-grained cleaning strategies to different interval segments, wherein the fine-grained cleaning strategies comprise dynamic threshold cleaning and static threshold cleaning, performing cleaning operations on the DBSCAN clustered data to obtain noise-filtered data, wherein the data cleaning module is connected to the interval clustering module;
an actual wind speed-power curve plotting module, configured to partition the noise-filtered data according to the wind speed intervals partitioned in the step S3, calculate average power within each wind speed interval to obtain a predicted wind speed-power data, and thereby plot an actual wind speed-power curve, wherein the actual wind speed-power curve plotting module is connected to the data cleaning module and the interval clustering module.
